(19) United States
(12) Patent Application Publication
(10) Pub. No.: US 2026/0078002 A1
(43) Pub. Date: Mar. 19, 2026

(54) METHOD & APPARATUS FOR Solar Nitrogen Fixation Container Farms

(71) Applicant: Ite Ed Chen, Captain Cook, HI (US)

(72) Inventor: Ite Ed Chen, Captain Cook, HI (US)

(73) Assignee: Lewa Farm Tech, Inc, Captain Cook, HI (US)

(21) Appl. No.: 18/885,865

(22) Filed: Sep. 16, 2024

(51) Int. Cl. C01B 21/02; A01G 9/18; A01G 24/10

(52) U.S. Cl. CPC C01B 21/02; A01G 9/18; A01G 9/243; A01G 24/10

(57) ABSTRACT

The patent details a novel method and apparatus for integrating solar nitrogen fixation into container farming systems. The core innovation revolves around a copper mesh electrode powered by solar energy to fix nitrogen directly from the atmosphere into forms usable by crops, such as ammonia. The system can operate independently from traditional nitrogen fertilizers and is designed to be modular and scalable for decentralized farming operations, particularly in urban or off-grid environments. The solar-powered nitrogen fixation process is efficient, utilizing low-voltage systems that eliminate the need for complex circuitry, enabling cost-effective, sustainable crop production. The nitrogen can be applied either via gaseous foliar feeding or through irrigation water, providing a continuous nitrogen source. This technology is especially beneficial for crops with high nitrogen demands, like leafy greens and herbs, offering an environmentally friendly and economically viable alternative to conventional nitrogen fertilization methods.

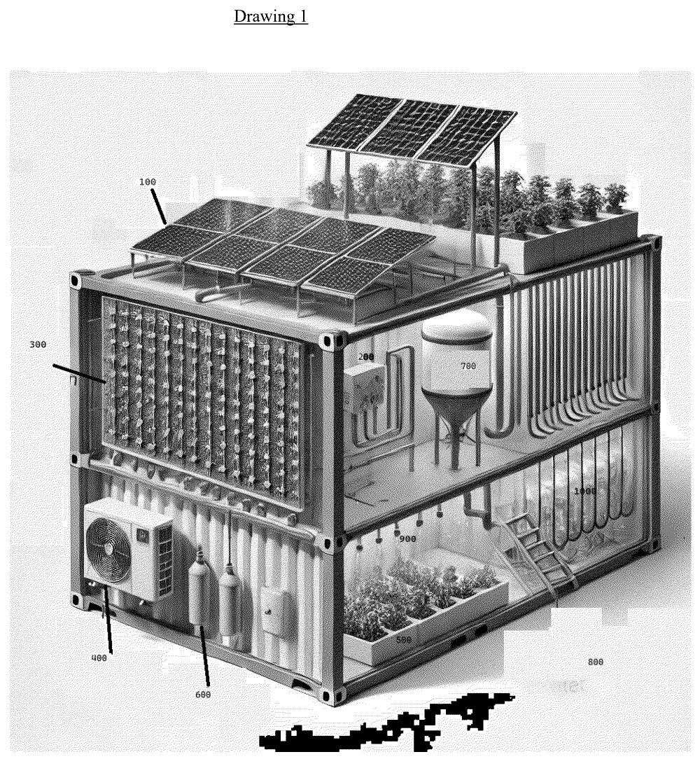

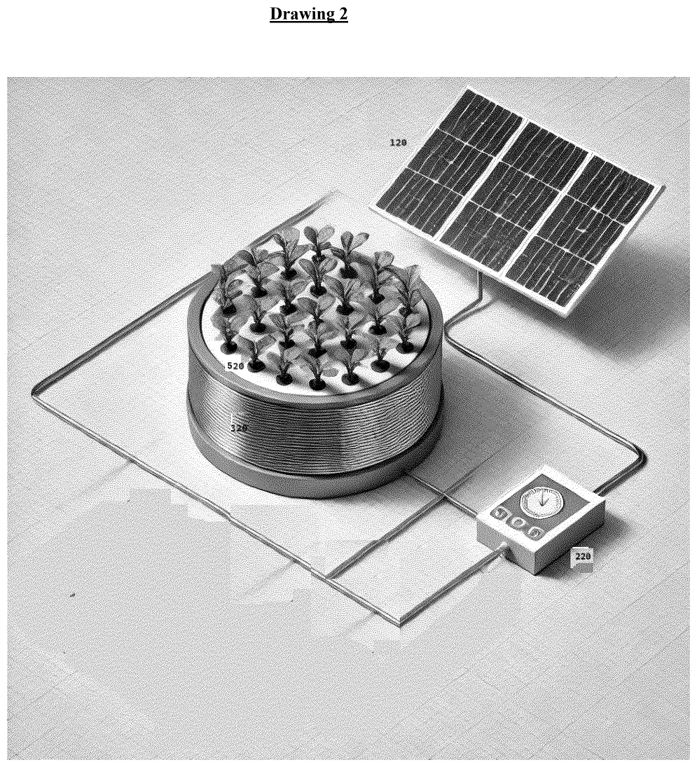

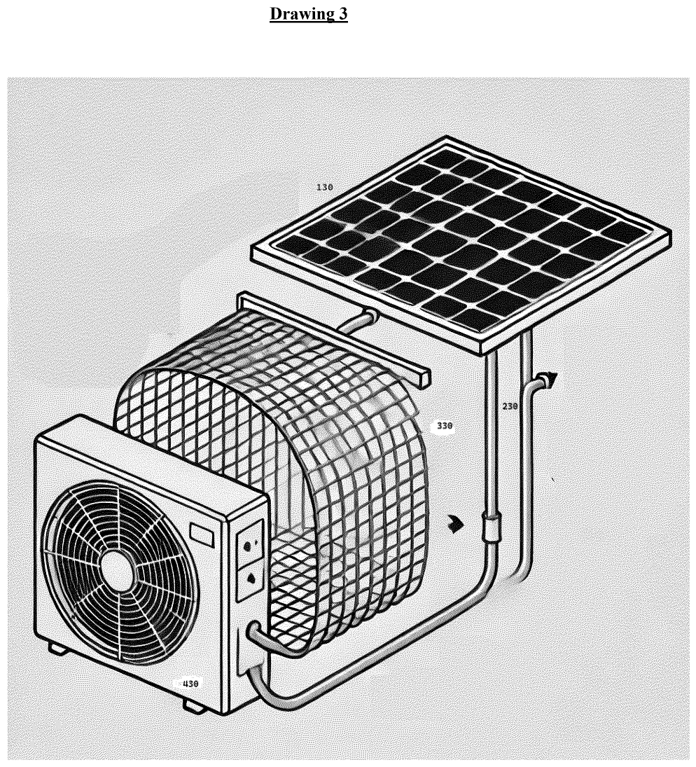

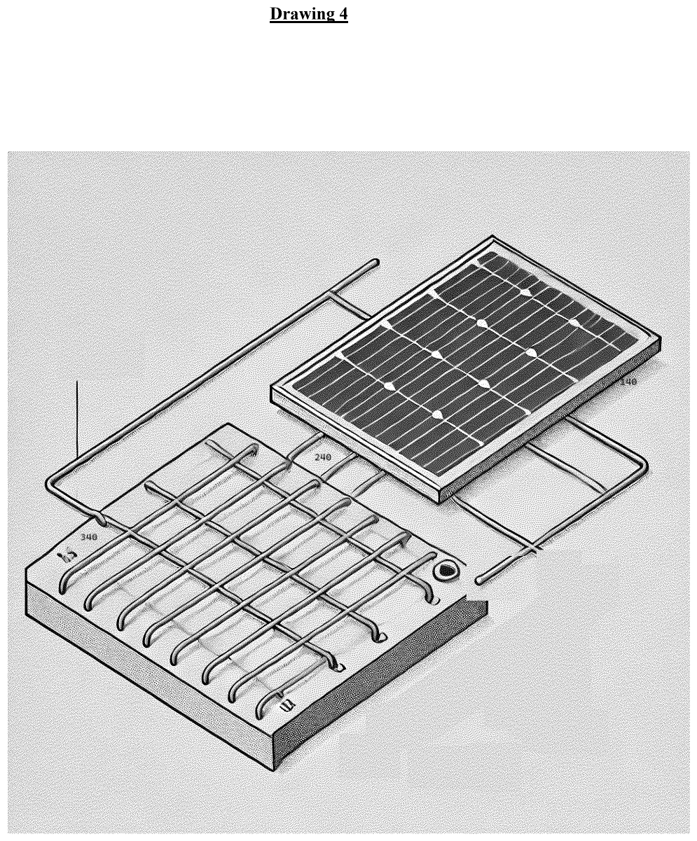

### CROSS REFERENCE TO RELATED APPLICATIONS

Method and Apparatus for the Electrical Activation of a Catalyst US20140275629A1.
Method and apparatus for in situ nitrogen fixation US20170183786A1

### STATEMENT REGARDING FEDERALLY SPONSORED RESEARCH OR DEVELOPMENT

### Not applicable.

### BACKGROUND

This section introduces information from the art that may be related to or provide context for some aspects of the technique described herein and/or claimed below. This information is background facilitating a better understanding of that which is disclosed herein. This is a discussion of “related” art. That such art is related in no way implies that it is also “prior” art. The related art may or may not be prior art. The discussion is to be read in this light, and not as admissions of prior art.

The Solar Nitrogen Farm Containers concept is an innovative development within the container farming field. Traditional container farms are primarily designed for crop cultivation using controlled environments with optimized light, climate, and irrigation systems. However, the integration of in situ nitrogen fixation in these systems, particularly utilizing solar energy, is novel. Prior patents by the inventor, such as WO2018151739A1, introduce methods involving a current limiting circuit to activate a catalyst using a current-limiting power supply or a solar panel acting as a current limiting power supply. This approach was previously unexplored in container farms.

Solar Nitrogen Fixation builds upon this prior art by eliminating the need for a current-limiting circuit. In previous methods, such circuits were crucial to stabilizing the reaction and preventing overloading. The current invention introduces the concept of a short-circuit ratio-calculated as the theoretical current divided by the short-circuit current-where a ratio above 1 enables the catalyst activation without additional circuitry. This simplifies the setup and makes the system more compatible with solar power, offering a decentralized and sustainable solution. The improvement lies in directly wiring solar panels in a short-circuit configuration without the use of a current limiting circuit, leveraging the naturally fluctuating output of solar panels to activate the catalyst. This is a significant departure from the earlier reliance on more complex electrical setups where the solar panel was not explicitly wired in a short circuit and was only used as a current limiting circuit.

In contrast, Patent US20140275629A1 discusses a system where the catalyst is wired in a short-circuit configuration with a current-limiting power supply, housed within a reaction chamber where reactants are introduced. The current invention refines this by allowing direct connection to solar panels in a short circuit, avoiding the need for a current-limiting circuit. This approach is more efficient and straightforward for solar-based applications. The distinct innovation is that the solar panels can be directly wired in a short-circuit configuration while maintaining a short-circuit ratio above 1.5, enabling catalyst activation without the previously necessary additional components of a current limiting circuit. This shift is what makes the Solar Nitrogen Farm Containers a novel and practical advancement in nitrogen fixation technology.

This invention improves upon the state of the art by allowing solar panels to be directly wired in a short-circuit configuration to activate the catalyst without the need for a current limitation circuit which generate spikes in the system. Prior patents do not discuss the necessity of this specific wiring setup, instead treating the solar panels primarily as current-limiting components to generate power spikes. The key innovation here is the combination of the previously patented short-circuit catalyst activation method (US20140275629A1) and in situ nitrogen fixation (WO2018151739A1), enabling a more efficient, integrated solution.

Several patents, such as U.S. Pat. No. 10,785,925B2 and U.S. Pat. No. 9,288,948B2, cover container farming technology with a focus on optimizing environmental conditions, vertical stacking, and lighting systems for high crop yields. However, none of these patents address nitrogen generation within a container. The Freight Farms patents, for example, focus on improving airflow, lighting, and monitoring systems but do not integrate nitrogen fixation technologies. U.S. Pat. No. 10,785,925B2 describes container-based systems optimized for high-yield crop production, featuring vertical racks, climate control, irrigation, and real-time monitoring systems for scalable and modular growth. U.S. Pat. No. 9,288,948B2 details similar container systems for integrating environmental control, monitoring, and vertical plant growth using advanced lighting and ventilation. Other Freight Farms patents, such as U.S. Pat. No. 10,271,486B2, focus on insulated containers for high-yield production by integrating vertical racks, lighting, and climate control systems, while U.S. Pat. No. 10,172,301B2 targets high-yield fungi production using specialized substrate preparation, pasteurization, and inoculation systems combined with vertical racks. U.S. Pat. No. 11,202,418B2 covers a modular container farm with a carousel system that rotates vertical grow towers, enhancing space utilization and plant accessibility. In addition, US20220039341A1 focuses on water generation within container farms, integrating water harvesting, nutrient supply, and climate control for optimized container-based agriculture, and US20230189718A1 describes stackable containers with integrated irrigation and misting systems, automated environmental controls, and scalable setups for vertical farming. While these patents cover innovations in container farming, they do not specifically address the integration of nitrogen fixation technology.

EP2788037A1 describes air plasma for nitrogen fixation aimed at reducing ammonia loss, but the process is energy-intensive and operationally sensitive. Your invention improves upon this by integrating solar-powered nitrogen fixation in container farms, making it practical for decentralized, off-grid setups. Recent advancements in plasma reactors, like dielectric barrier discharge (DBD), activate nitrogen for producing ammonia or nitric oxides, which aligns well with solar energy applications. Patents like US20230182104A1 describe plasma systems generating activated nitrogen species combined with hydrogen or oxygen for fertilizer production. Your approach stands out by directly harnessing solar power to achieve nitrogen fixation in a more sustainable, containerized environment. Additionally, catalysts like ruthenium or nickel enhance plasma-driven nitrogen fixation, making the process more efficient, which can further optimize your proposed system.

U.S. Pat. No. 5,192,355A outlines a process for producing nitrogen fertilizers using nitrous oxides generated from an arc system. While this concept is foundational, it lacks the integration required for container farming applications, particularly in off-grid environments. [Patent: U.S. Pat. No. 5,192,355A].

Plasma-Activated Water Technology: Research on plasma-based nitrogen fixation, such as the work described by Ye et al. in “Decarbonizing Nitrogen Fertilizer for Agriculture with Nonthermal Plasma Technology” (Eng 2024, 5, 1823-1837), explores methods for generating nitrate ions using plasma and atmospheric nitrogen. While promising, these methods are not yet optimized for integration into container farms, highlighting the practicality and innovation of this patent's solar-based approach [Patent: CN103653900B] [Reference: Ye, X. P. (2024). “Decarbonizing Nitrogen Fertilizer for Agriculture with Nonthermal Plasma Technology,” Eng, 5, 1823-1837. DOI: 10.3390/eng5030097] [Patent: US20140275629A1].

Methods of using concentrated solar power (CSP) to drive ammonia production have been developed, including processes that involve solar-thermochemical routes for generating nitrogen from air(American Institute of Physics, Sandia).

### SUMMARY

This invention is method to generate in situ available nitrogen for plants and applied to farm systems and farm technology.

The above paragraph presents a simplified summary of the presently disclosed subject matter in order to provide a basic understanding of some aspects thereof. The summary is not an exhaustive overview, nor is it intended to identify key or critical elements to delineate the scope of the subject matter claimed below. Its sole purpose is to present some concepts in a simplified form as a prelude to the more detailed description set forth below.

### DESCRIPTION OF DRAWING

The Four drawings are labels with corresponding numbers labeled to be described in the detailed description.

Drawing 1 is rendition of the container farm with in situ solar nitrogen generation with the gas being fed to the crops in both gaseous and liquid form.

Drawing 2 is a rendition of the solar nitrogen fixation technology connected to a wire mesh placed directly next to the farm crop and emitting the gaseous product onto the leaves of the plant without any HVAC or liquid intermediary to apply the nitrogen onto the crops.

Drawing 3 is a rendering the key components of a HVAC based solar nitrogen generating technology deployed in drawing 1.

Drawing 4 is a rendering of the key components of a mesh based gas emitter system being used in drawing 2.

The Solar Nitrogen Generation farming system has three key components as shown in these diagram and a series of other components for various embodiments of the system. The first component 1 is a power supply which generates electrical power labeled with the 100 series of components with specific labels of 100, 120, 130, and 140 and more specifically solar power in the embodiments. The power source is connected in a short circuit configuration labeled with the 200 series in the 4 drawings, more specifically 200, 220, 230, and 240, and part of the short circuit is a wire mesh from which air is fixed and emitted as parts per million or less of fixed nitrogen gases available to the crops, labeled 300, 320, 330, and 340 in the four drawings.

The fourth component which is an optional component used in certain embodiments of the invention. It is labeled with a series 400 in drawings 1 and 3 and is a HVAC system which draws air through the system across the wire mesh pulling air through the mesh to facilitate the conversion and circulating the air through the system which includes the farm crops. The 500 series in drawings 1 and 2 shows the crop and in one embodiment shown in drawing 2, the crop is surrounded by the mesh, while in embodiment 1, the crop is enclosed in a chamber whose circulation is driven by the HVAC system labeled in the 400 series.

600 700 900 and 1000 are components of the system which can function to fill the container farm with parts million available nitrogen gas without the use of a solar panel to generate the gases. 600 is a pressurized gas cylinder which contains the available nitrogen fertilizer gases such as ammonia or NO2 which is sent into a mixing chamber labeled 700 where the gases will be reduced to a parts per million dilution by mixing it with air. This resulting gas mix is sprayed onto the crop directly as a gas from nozzles positions above the crop plants labeled 900 in drawing 1, or it is mixed with water, labeled 1000 and irrigated into the crop medium, which can be soil or hydroponic. This system is contained in an enclosed space such as a shipping container labeled 800 in drawing 1.

### DETAILED DESCRIPTION

The present innovation relates to a modular farming system, specifically designed for controlled-environment agriculture (CEA), incorporating an integrated nitrogen fixation technology utilizing a copper mesh and solar power. The system is intended for containerized farming applications, offering enhanced crop yields, improved sustainability, and scalability.

Background: Traditional nitrogen fertilization methods rely heavily on synthetic fertilizers, which are energy-intensive to produce and environmentally harmful due to runoff and leaching. Current methods of nitrogen fixation, such as high-energy plasma systems, are costly and inefficient for small-scale or modular farming operations. This innovation addresses these challenges by offering an in-situ nitrogen generation system that is energy-efficient, scalable, and easily integrated into modular farming units.

### Summary of the Invention

The invention provides a self-contained, modular farming system designed for urban, peri-urban, and decentralized agricultural applications. It consists of a 20-foot or 40-foot container farm equipped with an integrated nitrogen fixation unit. The nitrogen fixation process uses a copper mesh electrode system powered by solar energy to convert atmospheric nitrogen into ammonia, which is then delivered to the crops through a controlled irrigation system. The design is optimized for scalability, allowing multiple container farms to be networked together, while the system's modularity ensures flexibility for various crop types and growth environments.

System Overview: The modular farming system is comprised of three key components: (a) a containerized growth environment, (b) a nitrogen fixation unit using a copper mesh system, and (c) an automated control and monitoring system.

Containerized Growth Environment: The base unit is a repurposed shipping container configured as a controlled-environment farm. The container is outfitted with vertical hydroponic or aeroponic grow systems, LED lighting, environmental controls (temperature, humidity, CO₂), and sensors for monitoring.

Nitrogen Fixation Unit: The nitrogen fixation system is the core of the innovation. It includes a copper mesh electrode array that acts as a catalyst for nitrogen fixation when powered by solar energy. The mesh is housed in a sealed HVAC chamber where air and water vapor are passed through, resulting in the production of ammonia and nitrate gas.

Alternate Nitrogen Fixation Unit: An alternative of the unit consists of copper mesh positioned between planting holes inside the unit and small solar panels configured in modular arrays underneath the LED lights getting the light to power the short circuit reaction directly from the LED lights. The circuit must be short enough to be considered a short circuit. Each circuit generates nitrogen fertilizer and feeds it direction to the plants in its immediate vicinity. The system is modular and each loop of mesh catalyst is fed with its own solar panel

This gas can be directly dissolved into the irrigation water, providing a consistent supply of nitrogen to the crops or it can be fed directly to the crops via gaseous foliar feeding. In one embodiment of the invention, as pictured in drawing 1, this method is carried out into practice as show in 600, 700, 800, 900, and 1000. The gas has to be bubbled into the water and the gas head above the water is recircuited back into the water solution until the gas is fully dissolved.

The copper mesh electrode system is optimized to operate at low voltage, making it compatible with renewable energy sources like solar panels. The system uses electrochemical principles to convert atmospheric nitrogen (N2) into ammonia (NH3), which is immediately integrated into the plants when the gas contacts the leaves. Drawing 4 shows this method where the mesh provides gaseous fixed nitrogen directly onto the plants 520 and the plants are surrounded by copper mesh. In this system, the plants have been shown to be able to acquire 100% of their nitrogen needs when provided with a constant flow of low ppm and ppb ammonia and nitrates into their system. The plants were stimulated to grow faster and plants which utilized an existing nitrogen feed also flowered more and gained additional color in their flowers and fruits. However, at higher ppms, the plants did burn from the nitrogen intake.

The design minimizes energy consumption and avoids the need for high-pressure or high-temperature conditions, and high voltage conditions making it both economically viable and environmentally friendly. By feeding the gas directly to the plants rather than through an intermediary carrier of water, the energy costs of the system were minimized.

The nitrogen generation system consists of a solar panel wired directly to the copper mesh in a short circuit configuration where the short ratio of the voltage to the rated system voltage is above 1 where the rated system voltage is above the voltage flowing through the mesh due to a short circuit. Higher voltages and currents will produce greater amounts of fixed and available nitrogen to the plants.

The “short ratio” is defined as the ratio of the rated system voltage divided by the short circuit voltage of the system. When this ratio is above 1, previously uncharacterized activation of the metal catalyst occurred. This catalyst can be other metals in addition to copper.

The nitrogen ions are generated on the surface of the wire mesh and dispersed into the air of the system in gaseous form. This gaseous nitrogen can be circulated and flowed through a HVAC system as shown in the 400 series of the drawings or the gaseous nitrogen can be generated directly next to plants, emanating off the mesh surface. However, keeping the gases recirculating through the HVAC system can be dangerous and can causes secondary products to occur such as hydrazine and cyanide. These catalysts may be connected to a single solar panel system on the surface of the system or it can be generated modularly using small independently wired solar panels in multiple short circuit systems around the plants.

Other aspects of the farm system may be soil, hydroponic, aeroponic, or any other means for growing plants. The nitrogen gas generated from the nitrogen generation system can provide 100% of the nitrogen needs of the system, allowing for total independence from external sources of nitrogen fertilizer and freeing up the growth medium to handle other nutrients, significantly boosting the output of the system.

However, this change in growth system also introduces problems to the system which will not be directly addressed. The Nitrogen can also be used in existing systems to boost output and nutrient quality of the crop.

Modular and Scalable Configuration: The system is designed to be modular, with each container or other farm system functioning as an independent farming unit. Multiple units can be linked together to form a network of farms, with centralized control for managing resources and maximizing efficiency. The modular design allows for easy transportation, rapid deployment, and flexible scaling depending on demand and available space.

Application and Use Cases: This system is intended for use in urban farming, decentralized agricultural projects, and as a scalable solution for commercial growers seeking to reduce their reliance on synthetic fertilizers. The system is particularly advantageous for crops with high nitrogen demands, such as leafy greens, herbs, and certain fruiting vegetables. By providing a closed-loop nitrogen source, the innovation not only enhances yield but also reduces the environmental impact associated with traditional farming practices.

Sustainability and Economic Viability: The integration of solar power and low-energy nitrogen fixation makes the system highly sustainable. The reduction in synthetic fertilizer use, coupled with the system's ability to operate autonomously, lowers operational costs, providing a steady ROI. The modular farms can be easily financed, bundled into securitized assets, or offered as part of franchise models, creating new opportunities for decentralized food production

Research and Development: Extensive field trials have been conducted to validate the efficacy of the nitrogen fixation system in different climates and for various crop types. The data collected indicates a significant improvement in crop yield and nutrient density, demonstrating the potential for broader commercial application. Additionally, ongoing R&D efforts focus on enhancing system efficiency, expanding crop compatibility, and integrating additional renewable energy sources.

What is claimed:

1. A method for in situ nitrogen generation using solar panels with backup battery supply or other DC or AC power source such as wind power or a battery connected to a metal wire mesh catalyst or other electrically activated catalyst directly in a short circuit configuration where the “short ratio” of the rated system voltage divided by the voltage going through the mesh is greater than 1 with or without a capacitor at the end of the system to collect any excess voltage and wherein the nitrogen gases are generated on the surface of the mesh and released into the agricultural system

2. The method of claim 1 wherein the nitrogen gas generated on the surface of the mesh or other catalyst is introduced into irrigation water to form nitrate ions or ammonium ions available to the plant or where ammonium is processed by a intermediary biotic digester

3. The method of claim 1 wherein the nitrogen gas generated and applied directly onto the roots and leaves exposed to the air of a plant.

4. The method of claim 1 applied to a modified shipping container or a controlled agricultural environment such as a greenhouse via a HVAC system

5. The method of claim 1 applied to a closed farm system such as a modified shipping container or a controlled agricultural environment, with open or closed ventilations such as a green house, modified container, or hydroponic system where the gas is applied directly to the leaves of the plants in the system with the available nitrogen gas emanating directly to the foliar plant surface.

6. A method for fertilizing agricultural systems wherein available nitrogen gas such as ammonia or NOx nitrate gases are applied to an open or closed farm system at parts per million levels or less.

7. The method of claim 6 applied to a modified shipping container or a controlled agricultural environment such as a greenhouse via a HVAC system.

8. The method of claim 6 applied to a closed farm system such as a modified shipping container or a controlled agricultural environment, with open or closed ventilations such as a green house, modified container, or hydroponic system where the gas is applied directly to the leaves of the plants in the system with the available nitrogen gas emanating directly to the foliar plant surface.

9. The method of claim of claim 6, wherein the available nitrogen gas is applied via foliar feeding or dissolved into irrigation water.

10. The method of claim 6 wherein the nitrogen gas is produced by the method of claim 1.

11. The method of claim 7 wherein the nitrogen gas is produced by the method of claim 1.

12. The method of claim 8 wherein the nitrogen gas is generated by the method of claim 1.

13. The method of claim 9 wherein the nitrogen gas is generated by the method of claim 1.
